(19) United States
(12) Patent Application Publication
(10) Pub. No.: US 2011/0296850 A1
(43) Pub. Date: Dec. 8, 2011

(54) Strainer System

(76) Inventor: Daniel W. McDonald, Shoreview, MN (US)

(21) Appl. No.: 12/852,571

(22) Filed: Aug. 9, 2010

Related U.S. Application Data
(63) Continuation-in-part of application No. 29/363,003, filed on Jun. 3, 2010, now Pat. No. D644072.

(51) Int. Cl. F25D 3/02; A47J 43/00

(52) U.S. Cl. 62/56; 99/495

(57) ABSTRACT

A strainer for use with combining beverages and cold food includes a bottom section sized for insertion into a beverage container, and a side section projecting substantially vertically from the bottom section and sized for insertion into a portion of such beverage container. A method for retaining ice in a container capable of holding a liquid includes placing a strainer capable of retaining ice in a container capable of holding a liquid, adding ice to the container such that at least some of the ice is retained by the strainer, placing a liquid in the container, and removing the strainer from the container. A strainer system includes a receiving cup for the strainer capable of being stored within the strainer, and may also include a sleeve member for engaging with the strainer to block holes in an upper region of the permeable side section of the strainer.

### RELATED APPLICATION

This application is a continuation-in-part of U.S. patent application Ser. No. 29/363,003 filed on Jun. 3, 2010, the entirety of which is hereby incorporated by reference.

### TECHNICAL FIELD

The present disclosure relates to an improved strainer system structured and adapted for a variety of uses with beverages and foods, including root beer floats and similar beverages involving liquids such as carbonated beverages and foods such as ice cream.

### BACKGROUND

A favorite cold and refreshing food treat for many people is known as a “float.” Floats typically include a beverage, such as root beer or orange soda, and a frozen dessert, such as ice cream or frozen yogurt, placed together in a glass. The person enjoying the float may, for example, eat the ice cream with a spoon, or drink the beverage with or without a straw. For some, a float combines the refreshment of a beverage with the cool relief of a frozen dessert all in one, with a combination of flavors being superior to either individually.

However, when making floats, a problem can arise when mixing the frozen treat with a beverage. Root beer, orange soda, and other beverages, especially carbonated beverages, tend to foam up significantly when poured from a can or bottle into a glass containing ice cream or another frozen treat. Sometimes, the beverage may fill only a fraction of the glass, while the foam rises to fill and even spill over the top of the glass. This creates a mess, as the foam may spill out. It also makes it difficult to pour as much of the beverage into the glass as is desired, without taking time or effort to remove the foam or cause the foam to subside, either by waiting for the foam's bubbles to burst, or by using a utensil of some sort to reduce or remove the foam. This dirties more utensils, takes time, increases the mess, and usually still leaves a substantial amount of foam beyond the desired amount.

Even if the beverage is poured in the glass before adding the frozen treat, the beverage can foam up, and it may splash when poured and cause a mess. The amount of foam may sometimes diminish somewhat if the beverage bottle or can is cooled before the beverage comes in contact with the frozen treat. However, foaming still occurs even if the beverage is cooled, and it is often desired to make a float using a beverage when there has been no time or opportunity to cool the beverage can or bottle in advance of making the float.

It is thus desirable to have a method of making floats that reduces the amount of foam in the float produced by the carbonated beverage with a minimum of effort and mess.

It is also desirable in some circumstances to have ice, fruits, garnishes, or other foods or cooling items come in contact with a beverage poured into a drinking container such as a glass or cup, without remaining in the container. For example, people with temperature-sensitive teeth may want a beverage that is cool, but encounter discomfort if a beverage container with a drink contains ice that may come in contact with their teeth. Also, it is desirable to serve some beverages, such as wine and certain other alcoholic drinks, at a chilled temperature, but without ice remaining in the beverage container that may dilute the beverage or lack the desired appearance.

Straining devices, including the Hawthorne strainer and a julep strainer, exist to strain ice or garnishes as they are poured into beverage containers. However, such strainers have limited utility beyond their specific purposes or with different sizes and shapes of beverage containers. Moreover, these devices are not designed for use with carbonated beverages or by children, who may participate for example in making root beer float-type beverages. Moreover, these and other prior art strainers can create a mess when used with beverages or to rinse foods. Carbonated beverages may bubble and foam quickly when poured over the strainer, and seep through these prior art straining devices to create a mess while in use. Even after the strainers are done being used and are allowed to drain for a period of time, such strainers may continue to drip water or liquid. These strainers are not suitable for draining and serving foods such as fruits or vegetables. Such strainers as well as other typical strainers are not used for serving, at least because of this leakage problem. These strainers have no means by which to change their structure, shape or features to adapt to different sizes and shapes of beverage containers or different purposes. A strainer that can be adapted for use with such standard glasses as well as wine glasses and other glasses with rims that do not extend above some holes in the strainer would be desirable.

Some wines are recommended to be served at temperatures slightly or significantly lower than room temperature. While wines may be stored in refrigerators or cellars to maintain a desired temperature, often times such storage is unavailable or limited, or time constraints preclude refrigeration from reducing the wine to the desired temperature. Serving wine over ice may reduce the temperature of the wine, but is viewed as undesirable by many wine drinkers for a number of reasons, including its tendency to cool the wine below the desired serving temperature and the dilution of the wine that may arise from the ice melting while in the wine. Plastic “ice” cubes may be used to cool wines, but need to be cooled or frozen in advance of use, and may provide an appearance to the wine glass viewed by some as undesirable. A system and method for rapidly cooling wine to desired temperatures without serving the wine on ice would be desirable.

A strainer system which reduced or eliminated these and other problems while being adaptable for different uses and different shapes and sizes of beverage containers would be desirable. It would also be desirable that any strainer system adaptable for the above-described uses be efficiently designed to minimize the amount of space needed for use and storage.

### SUMMARY

The present disclosure is directed to a strainer system which reduced messes and is useful for a variety of purposes including making root beer and other float-type beverages. Disclosed is a system including one or more of a strainer, a cup for receiving the strainer, and a sleeve for changing the effective height of the straining zone of the strainer. The strainer may comprise a generally circular bottom section sized for insertion into a single-serving beverage container; a side section projecting substantially vertically from the bottom section and sized for insertion into a single-serving beverage container; at least one of the bottom and side sections being liquid permeable; the bottom section and side section separately or collectively capable of retaining ice pieces, garnishes, or items to be rinsed such as fruits or vegetables when the strainer is lifted from a single-serving beverage container. In some embodiments, the strainer has an upper portion with a shoulder or projecting region that is capable of resting on or abutting a top portion of a beverage container or retaining a receiving cup.

A cup for receiving the strainer and retaining drainage from the strainer is provided. The cup may be of a standard size used for measuring serving portions, such as one cup (eight ounces). The cup may have a flange section extending around its top rim, with recesses at the location of extensions at the top of the strainer, such that the cup may be retained insider the strainer when not in use.

A sleeve is provided which may be sized and tapered to fit within the strainer and extend a portion of the distance into the strainer. Alternatively, the sleeve may be sized and tapered to slide on the outside of the strainer. When inserted into or slid onto the outside of the strainer, the sleeve blocks the drainage out of the upper portion of the holes in the strainer, rendering the combination of the strainer and sleeve suitable for wine glasses or other beverage containers. The sleeve that slides onto the outside of the strainer may also have a laterally extending shelf portion that may rest on the upper rim of a glass or other container to further inhibit leakage or spillage of foam or liquid above the top rim of the container.

Also disclosed is a method for exposing a liquid to ice or another cooling surface and removing at least some ice pieces or a portion of the cooling surface from a container capable of holding a liquid comprising: inserting a sleeve inside of a strainer or sliding a sleeve on the outside of a strainer as described above, placing a strainer with such sleeve engaged therewith and capable of retaining ice pieces into a container capable of holding a liquid; adding ice to the strainer; pouring a liquid over the strainer and into the container or otherwise placing a liquid in the container; and removing the strainer from the container. In some embodiments, such as with wine, this process effectively cools the wine without extended contact between the wine and the ice in the strainer. In other embodiments, such as with making floats, the remaining liquid can then be combined with a cold treat with significantly reduced foaming of the beverage. In one embodiment of the method comprises inserting a sleeve inside of a strainer or sliding a sleeve on the outside of a strainer as described above, placing a strainer with such sleeve engaged therewith capable of retaining a plurality of ice pieces in a container capable of holding a carbonated beverage; adding a plurality of ice pieces to the strainer; pouring a carbonated beverage over the strainer and into the container or otherwise placing a carbonated beverage in the container such that the carbonated beverage is cooled; and removing the strainer from the container. Ice cream or other frozen treats may be added to the beverage in a variety of sizes and shapes of glasses and other containers with significantly reduced foaming and mess. The strainer, sleeve, and cup may be sized such that, when not in use, the sleeve and cup may be stored inside the strainer or the strainer stored inside the sleeve or cup, reducing the storage space needed.

The above summary is not intended to describe each disclosed embodiment or every implementation. The figures and the detailed description that follow more particularly exemplify these embodiments.

### DESCRIPTION OF DRAWINGS

FIG. 1 shows an example embodiment of a strainer.

FIG. 2 shows a bottom section of the strainer of FIG. 1.

FIG. 3 shows another example embodiment of a strainer.

FIG. 4 shows another example embodiment of a strainer.

FIG. 5 shows another example embodiment of a strainer.

FIG. 6 shows an example method for using a strainer.

FIG. 7 shows the strainer of FIG. 1 having ice cubes therein and positioned in an example glass.

FIG. 8 shows the strainer and glass of FIG. 7 with an example beverage being poured into the glass.

FIG. 9 shows the strainer and glass of FIG. 8 with the strainer being partially removed from the glass.

FIG. 10 shows the glass of FIG. 9 with the strainer completely removed therefrom.

FIG. 11 shows a perspective view of another embodiment of a strainer.

FIG. 12 shows a side view of the strainer of FIG. 11.

FIG. 13 shows a top view of the strainer of FIG. 11.

FIG. 14 shows a perspective view of the strainer of FIG. 11 positioned in a sleeve.

FIG. 15 shows a side view of a strainer stored in a receiving sleeve.

FIG. 16 shows a perspective view of another embodiment of a sleeve positioned within the strainer of FIG. 11.

FIG. 17 shows a perspective view of the sleeve of FIG. 16 removed from the strainer.

FIG. 18 shows a side view of another embodiment of a sleeve for inserting in a strainer.

FIG. 19 shows the sleeve of FIG. 18 inserted in a strainer, in use with a wine glass.

FIG. 20 shows a side view of another alternative embodiment of a sleeve for sliding on the outside of a strainer.

### DETAILED DESCRIPTION

The present disclosure is directed to a strainer system useful with preparing floats such as root beer floats, and an apparatus useful in making root beer and other float-type beverages as well as other cooled or mixed beverages, and for rinsing and draining foods such as fruits and vegetables, for use with a variety of beverage or other containers, and with a minimum of mess during and after use.

As used herein, “carbonated” beverages generally refers to beverages that are capable of generating bubbles or foam when poured, whether or not this capability arose through a process that would be considered by one of skill in the art to be a “carbonation” process or not.

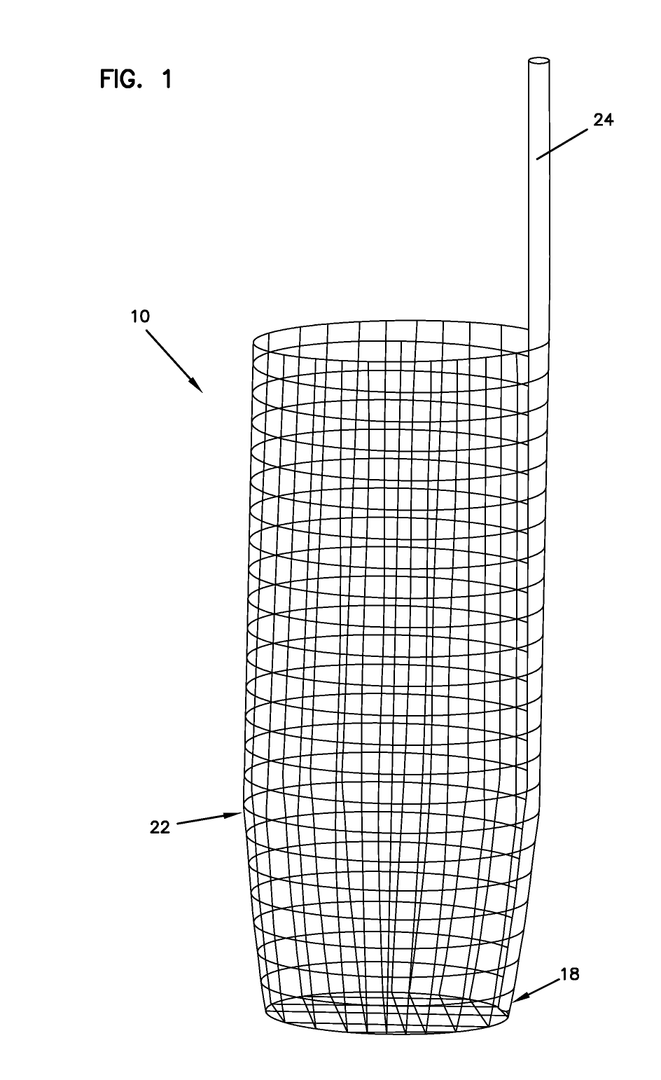

One example embodiment of a strainer 10 is shown in FIG. 1. Additional details regarding strainer 10 can be found in U.S. Pat. No. 7,685,936, which is hereby incorporated by reference.

Strainer 10 as shown has a generally circular bottom section 18 connected to a generally cylindrical side section 22. The strainer allows liquid to pass through it upon removal from glass, but has apertures or another straining structure to either retain foamy residue of carbonated beverage or to reduce the foamy residue by contacting bubble-like surfaces.

An optional gripping member 24 is connected to side section 22 and provides a surface to grip by hand or otherwise for lifting or moving the strainer. This gripping member 24 may project from side of strainer 10 so that the member 24 may rest on the top edge of a beverage container in which the strainer is placed for easier removal, especially when the strainer is shorter than the beverage container.

The strainer as shown is shaped generally cylindrically to fit within a drinking glass or other beverage container. The strainer need not be generally cylindrical, but can be shaped such that its width is generally narrower than the interior diameter of the beverage container with which it will be used.

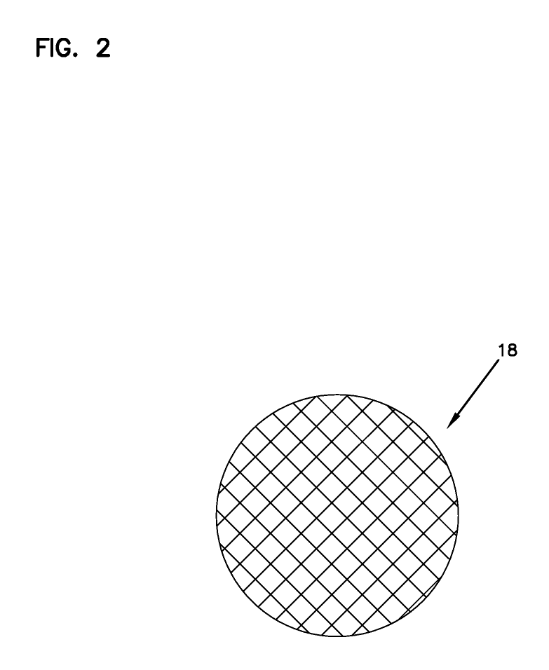

FIG. 2 shows a bottom view of strainer 10 with bottom section 18. The bottom section as shown is generally circular, but could be oval, square, or some other shape.

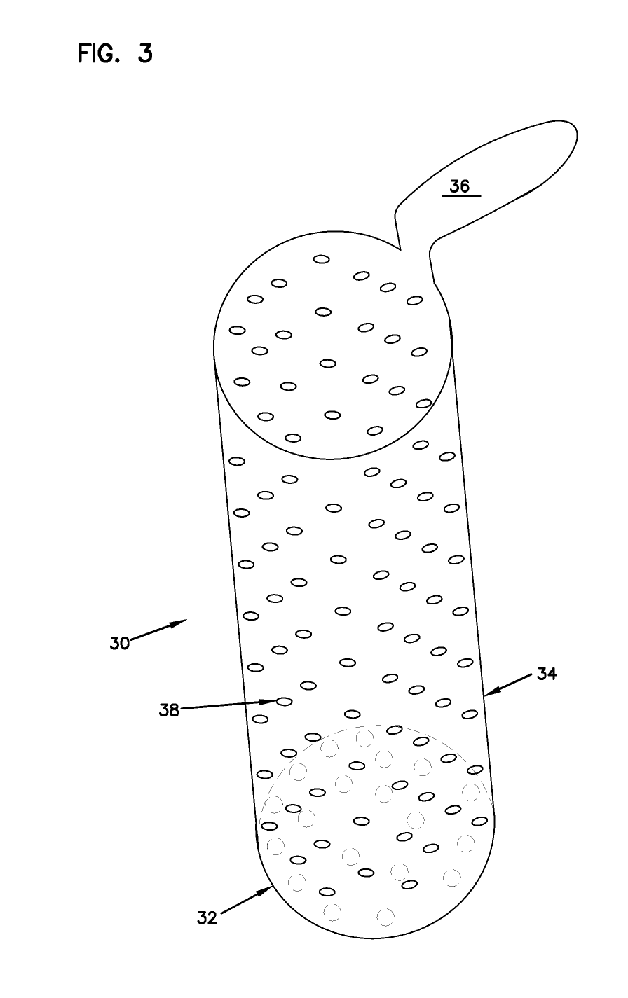

As shown in FIGS. 1 and 2, the strainer is liquid permeable through use of a wire mesh construction. Alternatively, either or both of the bottom or side sections of the strainer may use an alternative liquid permeable construction such as that shown in FIG. 3.

FIG. 3 shows an example strainer 30 with a bottom section 32, side section 34 and optional grippable member 36 comprising a material having holes such as hole 38. This construction may utilize an integrally formed plastic material. Alternatively, a combination of materials may be used.

Either the bottom or side sections may in whole or in part lack permeability, although one of the two sections may have some capability of allowing liquid to exit the strainer when it is removed from a beverage container while the strainer remains capable of retaining ice pieces.

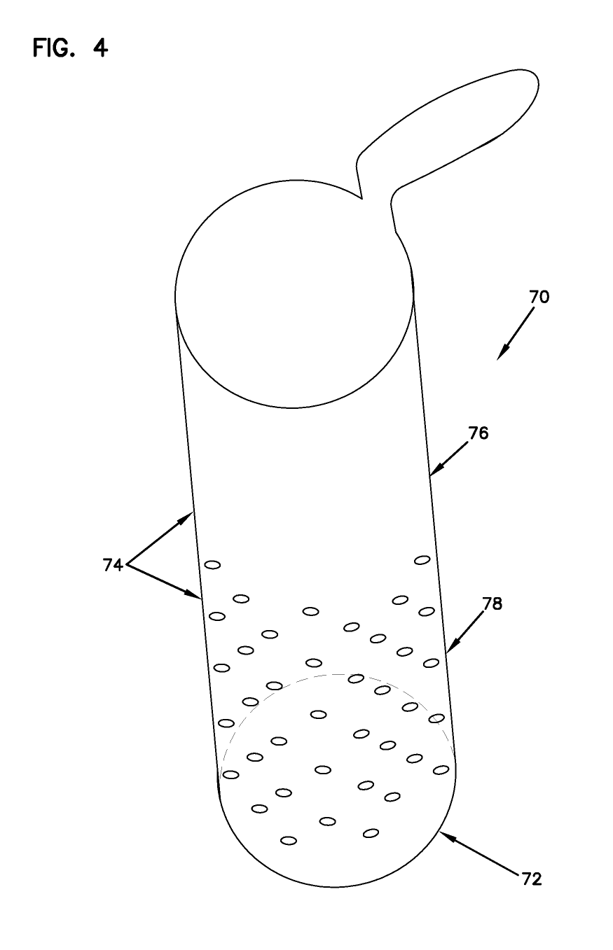

For example, FIG. 4 shows another embodiment of a strainer 70 wherein bottom section 72 and an upper section 76 of side section 74 are not permeable, but the remainder 78 of side section 74 is permeable to liquid.

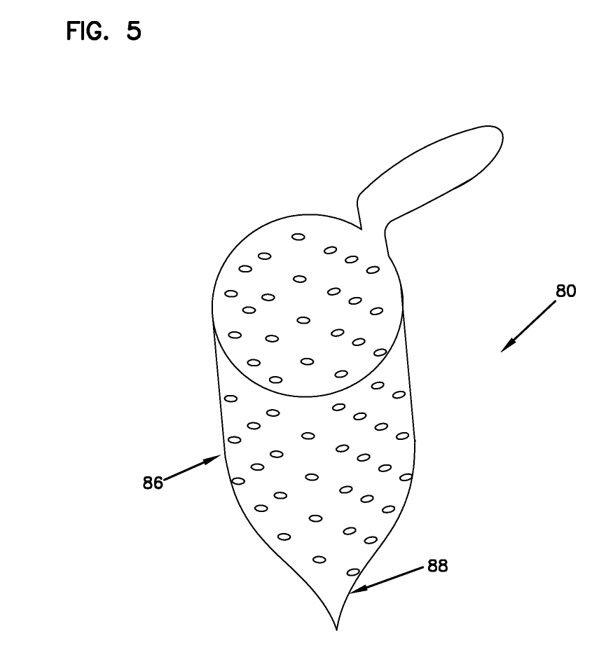

As another alternative, the strainer may have a construction as shown in FIG. 5. FIG. 5 shows a strainer 80 with side section 86 shaped so that it also provides the bottom section through a tapering section 88 at the bottom. The tapering section may enclose the bottom, or generally narrow at the bottom to leave an opening. In the example shown, tapering section 88 of strainer 80 forms an inverted cone shape.

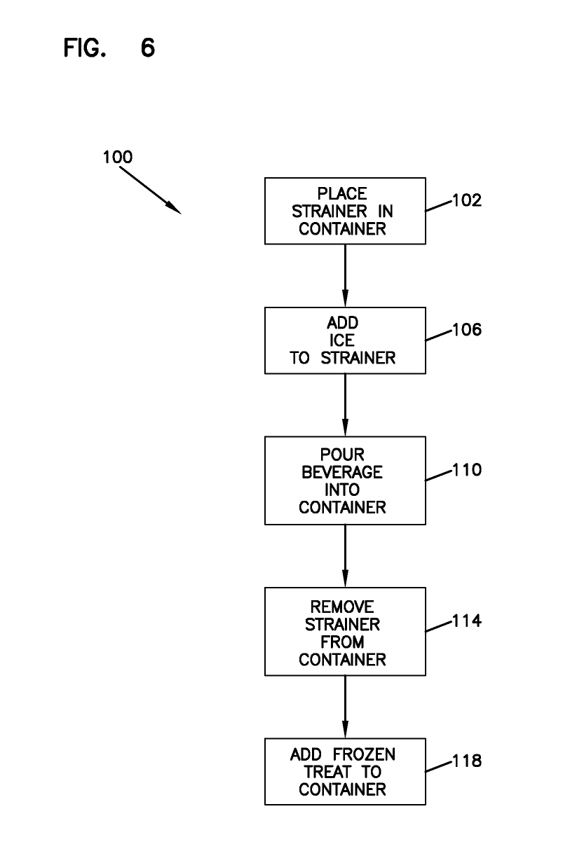

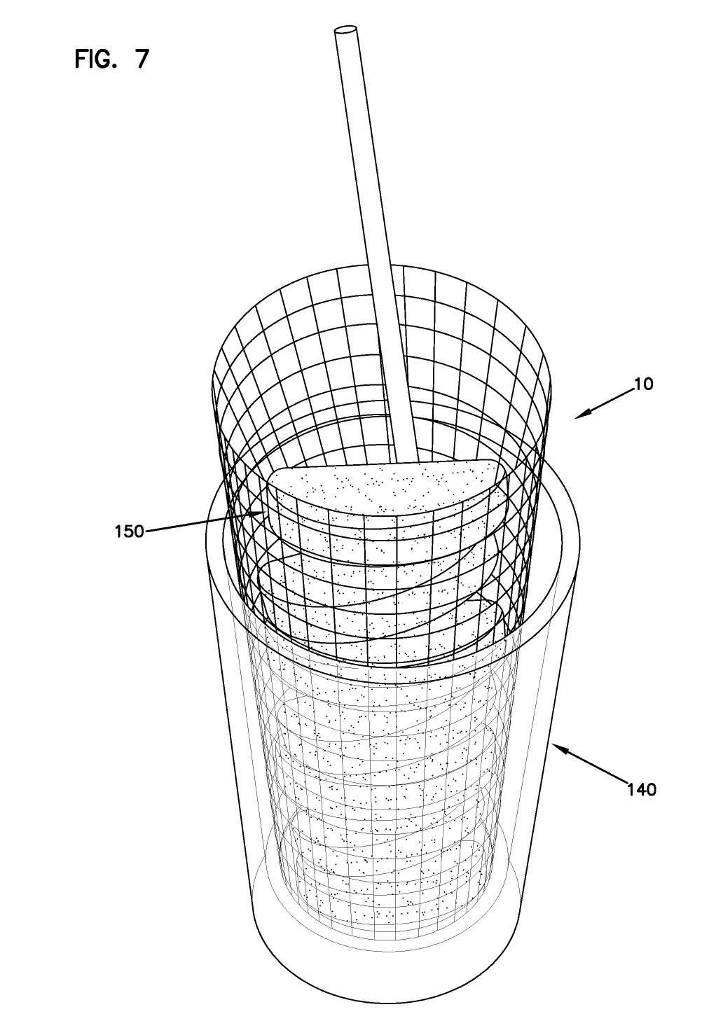

An example method of using the strainer is now described. As shown by flow chart 100 in FIG. 6, the strainer is placed in a beverage container such as a glass in step 102. At step 106, ice cubes or other ice pieces are placed in the strainer. When the strainer is in the glass and has ice (or some other beverage cooling material, although herein such materials are called “ice” to include both ice and such other materials, such as cooling plastic cubes) in it, it may have the appearance of FIG. 7.

FIG. 7 shows a container such as glass 140, holding strainer 10 having ice 150 inside. The order of steps may vary, but generally it is preferred to place the strainer in the container before placing the ice in the strainer.

With the ice in the strainer and container, the beverage is poured into the glass as indicated at step 110 of FIG. 6. Again, the beverage may be poured into the glass before the strainer with ice is added, but generally it is preferred to perform the steps in the order depicted in FIG. 6.

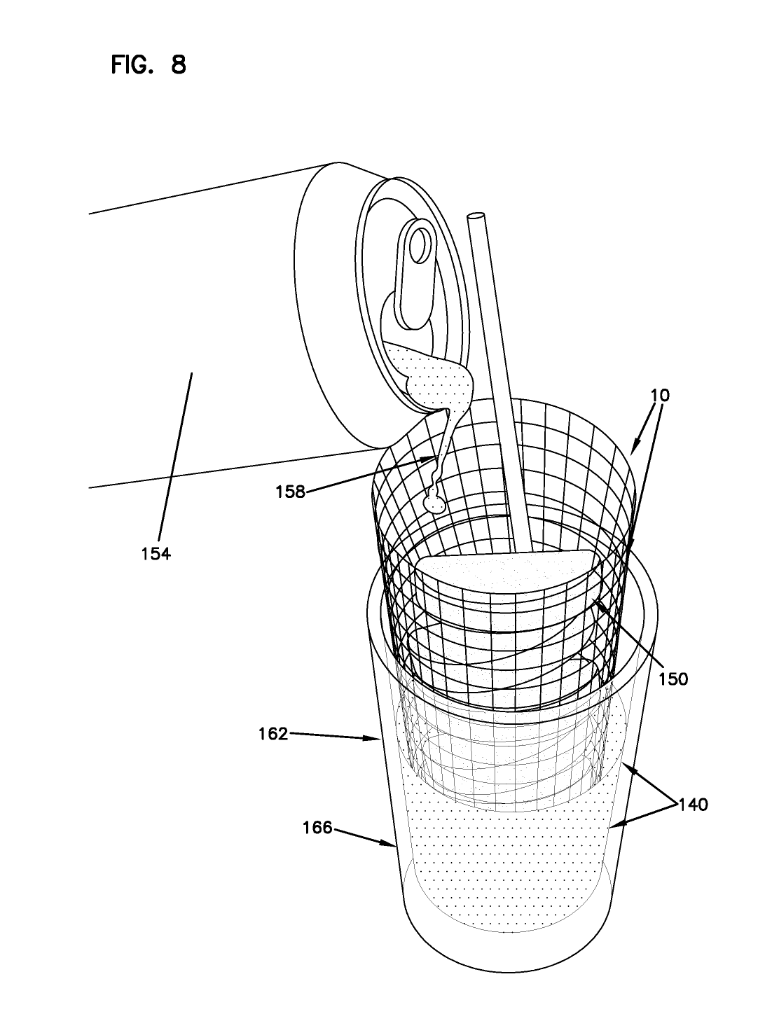

FIG. 8 shows one example of step 110. A can 154 having a beverage 158 such as root beer or another carbonated beverage is poured into glass 140. Foam 162 forms when the beverage 158 is poured into glass 140 having strainer 10 and retaining ice 150. Liquid 166 is also retained in glass 140.

In the example method shown, the liquid poured into the glass is a carbonated beverage such as root beer, a cola beverage, or a flavored soda such as orange or lemon-lime flavored soda. When the carbonated beverage contacts the ice, bubbles and/or foam (e.g., foam 162) may be created, and the beverage will probably be cooled (depending in part on its temperature when poured). Typically, the bubbling or foam production will slow and bubbles or foam disappear within a few seconds or moments.

Once some amount of time has passed after the beverage and ice contact each other, the strainer is lifted out of the container as indicated at step 114 of FIG. 6.

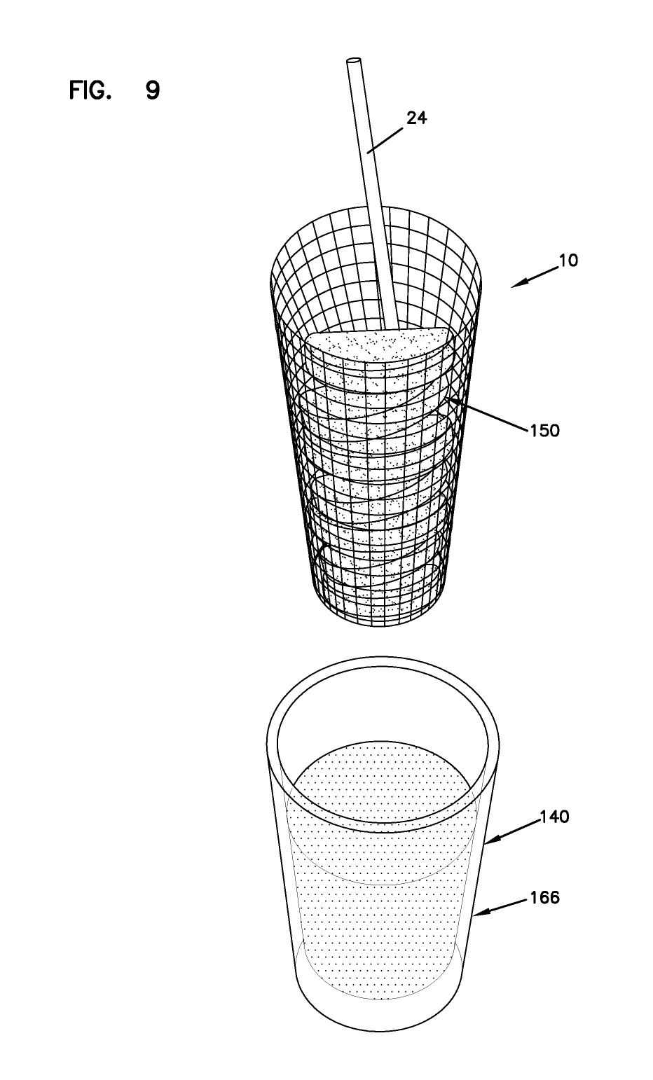

As shown in FIG. 9, the optional gripping member 24 may (or may not) be used for this step. When the strainer 10 is removed from the beverage container 140, the beverage 166 generally remains in the container, while the portions of the ice 150 that do not melt or slip through the strainer will be removed from the container along with the strainer. Depending on such factors as the size of the ice pieces and the amount of time that the ice sits in the container, the ice may be a significant portion of the ice added to the strainer originally, or not.

The strainer may be removed to another location, such as a sink or bowl, where the ice may be dumped out, allowed to melt, or retained for possible re-use.

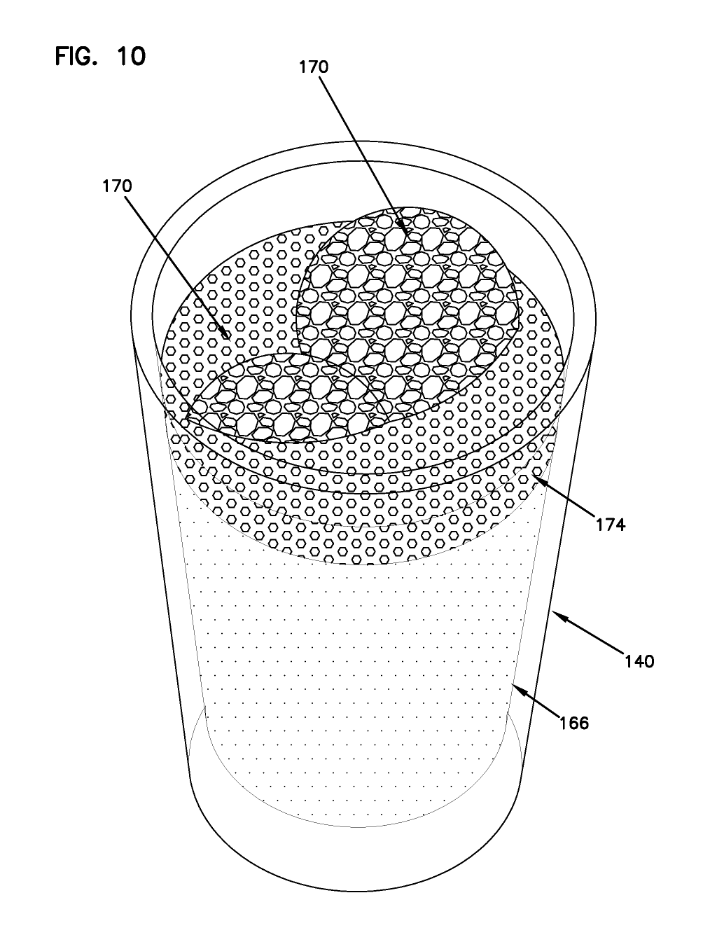

Once the strainer is removed, ice cream or other suitable cold food such as sherbet, ice milk, or gelato, is added to the container to make a float. This step is described at step 118 of FIG. 6 and in FIG. 10. Because the liquid 166 in the container 140 has already had an opportunity to bubble or create foam, i.e. has “lost its fizz” at least in part, the additional of the cold food 170 will typically generate substantially less foaming or bubbling than would be generated had the beverage been poured into the container having the cold food inside. This allows the container to retain a greater amount of the beverage and cold food without having as much foam and with the combination less likely to overflow the container.

Alternatively, ice generally cools the beverage directly, but may also cool the strainer or the glass, for example when the strainer is made of metal. In that situation, the ice may be added to the strainer to make the strainer cold, and then removed before the beverage is poured in. The strainer may also be made of a material that would allow it to be placed in a freezer to be cooled down, then inserted into the beverage container and used to cool the beverage without adding ice.

Often, once the cold food is added, there maybe room in the container to pour more beverage in. An optional additional step includes adding more of beverage, such as the carbonated beverage originally poured into the container. Even though the added carbonated beverage may retain significant “fizz” or carbonation when poured, and create some foam such as foam 174 in FIG. 10, generally adding a beverage to the container already having the cold food and some beverage in the glass will generate less foaming or bubbling than had the above-described process not been followed, and excess foaming and spillage will this still be avoided.

By using the strainer structure described herein, with the various methods described or otherwise, root beer floats, orange floats, and other drinks incorporating carbonated beverages and cold foods can be enjoyed with more of the beverage and food in the container, and less foam, bubbles, and mess.

In example embodiments, the generally cylindrical shape for the strainer also provides the advantage of fitting easily in the proper location for receiving ice under automatic ice dispensers as are found, for example, on the front of many refrigerators. The strainer can, but not necessarily, have a rigid construction that facilitates activation of a lever that typically initiates dispensing ice from such ice dispensers.

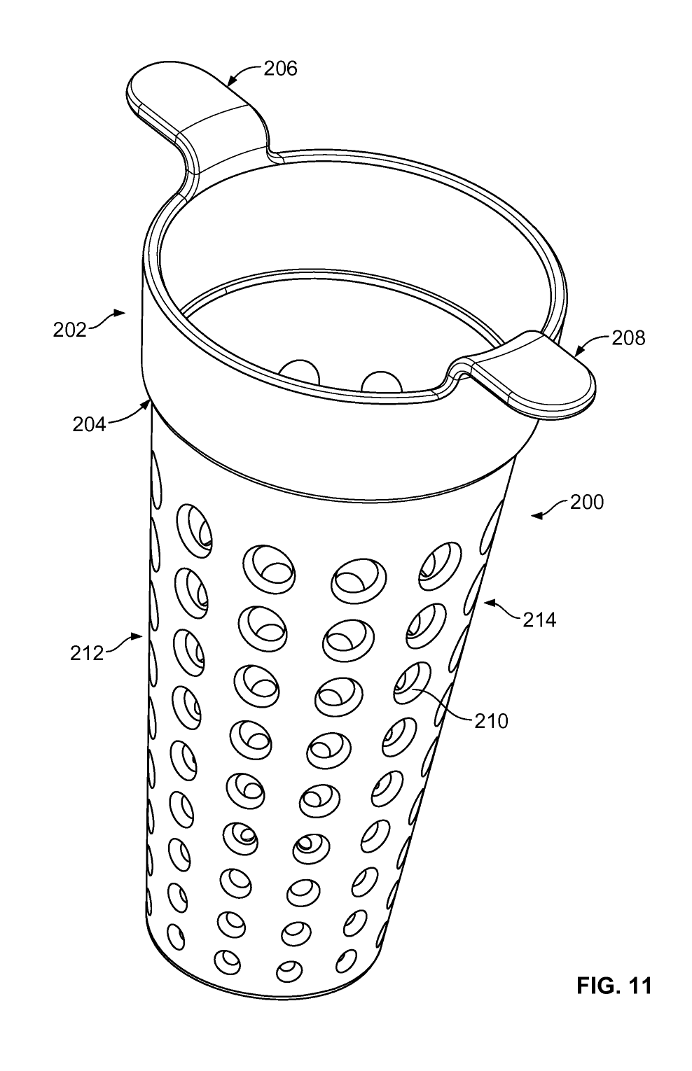

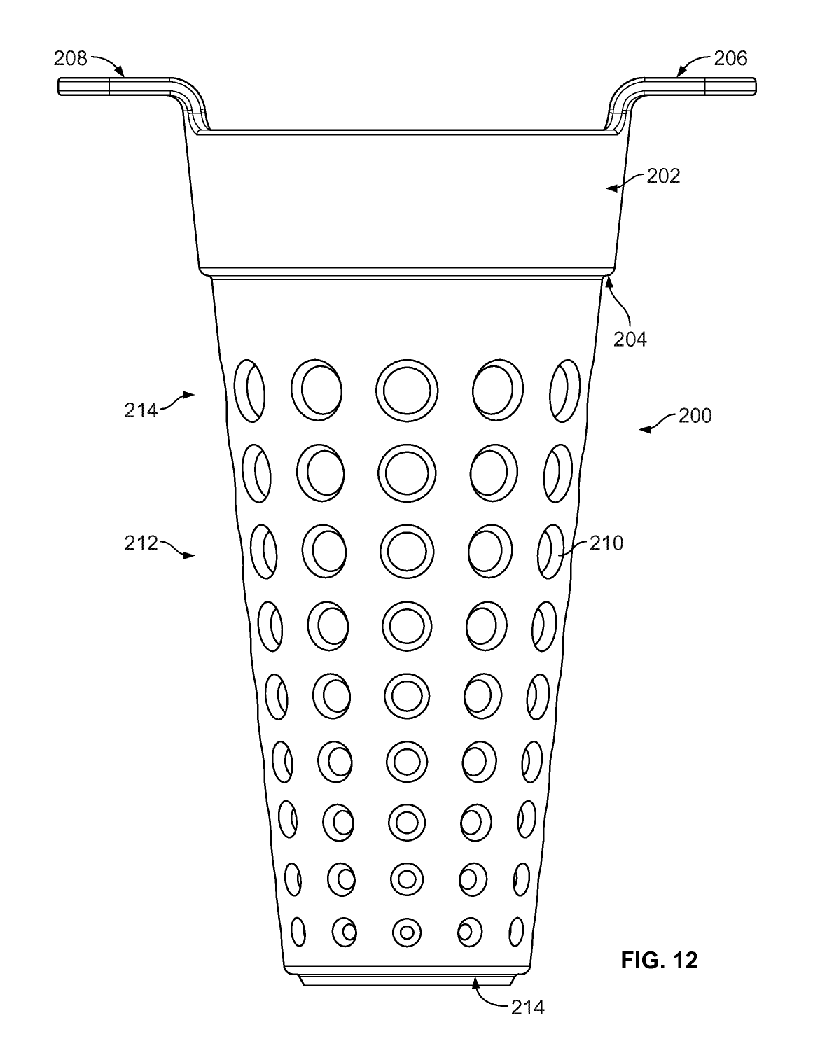

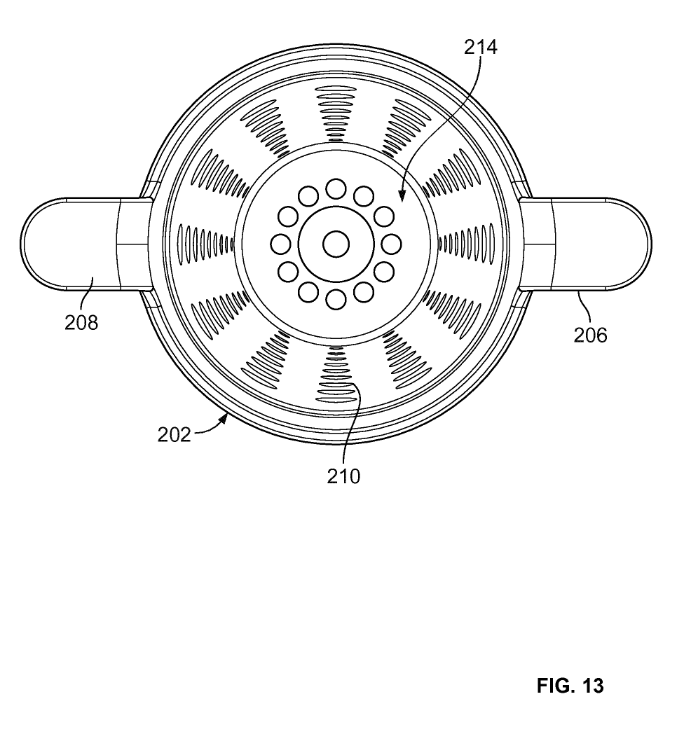

FIGS. 11-14 show another embodiment of a strainer 200. The strainer 200 has a tapering or conical shape suitable for insertion into a beverage container such as a glass or mug. The upper portion 202 is wider than the lower portion 212. The upper portion 202 has a shoulder or projecting portion 204 at its lower end. At least the lower portion 212 has holes for drainage and straining. A middle portion 214 may also have drainage holes, or the holes in this region may be eliminated to reduce leakage. The strainer may be used with a sleeve as discussed below, especially when the strainer has holes in the upper region 214. FIG. 13 also shows a bottom section 214 of the strainer, which may have holes. The strainer as shown has rows of generally circular holes, but a variety of shapes and configurations may be used, such as generally oval shaped holes or holes in generally diagonal patterns or in various geometric shapes and patterns such as generally elliptical, circular, and triangular.

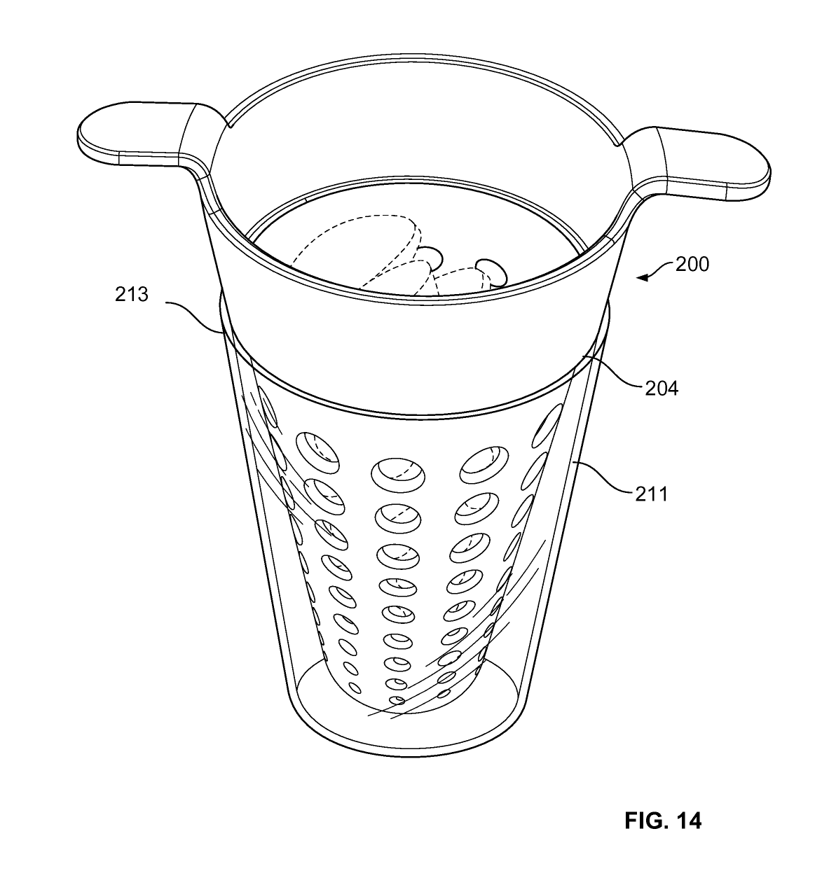

As shown in FIG. 14, the projecting portion of shoulder 204 may abut the top or inside 213 of a beverage container 211 when the strainer 200 is inserted into a beverage container, substantially eliminating significant gaps between the outside of the strainer and the glass or other container in which the strainer is placed. This may be desirable to impede beverages or the foaming or bubbling of beverages over the top rim of the beverage container when the strainer is inserted into a beverage container, reducing messes. The shoulder or projecting portion 204 may project around substantially the entire circumference of the strainer such that it is capable of resting on substantially the entire the top edge of a beverage container in which the strainer is inserted, also impeding the leakage of foam, beverages, or other substances over the top edge of the container and reducing spillage. The upper portion 202 may also have a thicker or sturdier construction than the lower portion 212, to facilitate resting the strainer on the top rim of a glass or other container as well as to facilitate use of the strainer with levers used to dispense ice from automatic ice makers.

The strainer shown in FIGS. 11-14 also includes optional flanges or extending portions 206 and 208. These flanges provide a gripping area to remove the strainer from beverage containers or otherwise transport or rotate the strainer. The flanges as shown also project laterally such that the strainer may rest atop even beverage containers with particularly large openings, such as souvenir cups sold at sporting events. The flanges may also be shaped to fit with recesses in a receiving cup, as described below. The flanges may alternatively take the form of a laterally projecting rim that extends around the entire circumference of the strainer, to provide another structure for reducing or preventing spillage over the top edge of the strainer.

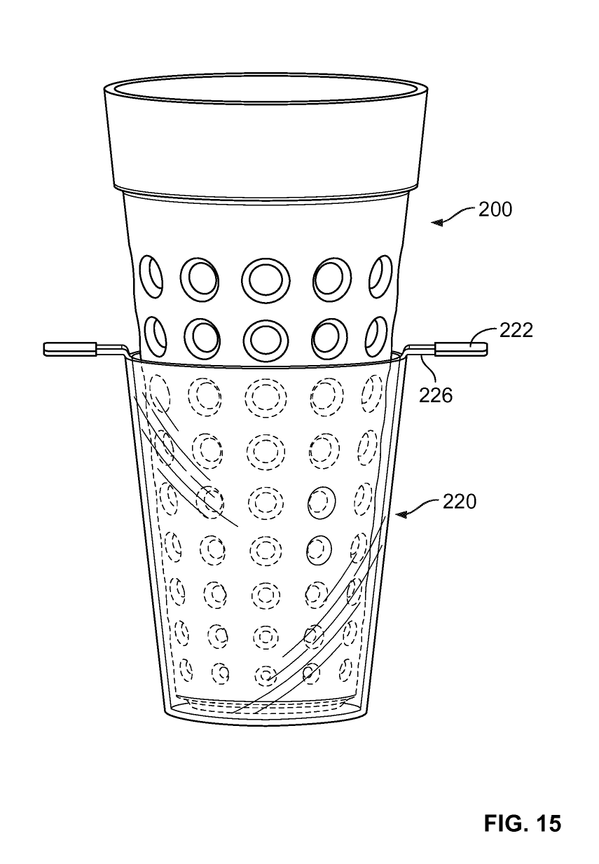

FIG. 15 shows a strainer system including a strainer 200 as described above, and a receiving cup 220. Receiving cup 220 is sized to receive strainer 200 such that strainer 200 remains in a generally upright position, rather than tipping over. The strainer 200 may be inserted into the cup when filled with ice or after being used to prepare a beverage or rinse food, so that the cup may collect any melting ice, water or other drainage. Receiving cup 220 may have an upper rim 226 with recesses 222 shaped and sized to allow flange 206 and 208 to fit within the recesses when the receiving cup is stored within the strainer. Receiving cup 220 may also be used to measure or receive servings of fruits, vegetables, other foods or beverages, or ice. An interior size for the receiving cup may be one-cup (eight fluid ounces), a common serving portion.

The receiving cup and strainer system may be used in a variety of ways. For example, a serving of fruit may be poured into receiving cup 220. The cup may be sized as described above to measure the appropriate serving size, or include markings corresponding to desired serving sizes. The serving of fruit or vegetables may then be poured into strainer 200. The fruit may be rinsed within strainer 200. Once the fruit or vegetables are rinsed, the strainer may be stored within the receiving cup as shown in FIG. 15. The material used for the strainer and cup may be suitable for use in a microwave oven, in which case food may be heated in the strainer and cup before serving. In any event, the combination strainer and cup may be used to serve the fruit or vegetables, eliminating the need to transfer the drained or heated food to a different serving container. The cup also serves to retain any moisture or other material that may continue to drain from strainer 200 after rinsing or use.

The strainer system may also be used for cooling wine. The strainer system may quickly reduce the temperature of wine without requiring that the wine be served on ice, which is considered undesirable by some people for many wines. The strainer may be placed in a wine glass, and the sleeve insert placed with the strainer. In one embodiment the strainer lacks holes in the upper region 214 so its liquid permeable section does not extend over the rim of the wine glass, to minimize spillage or leakage. The strainer may be wholly or partially filled with ice cubes, ice chips, crushed ice, or ice in other forms. The wine may be quickly poured through the strainer and into the wine glass, and the strainer removed from the wine glass in a matter of seconds. Even quickly exposing the wine to crushed ice in the strainer has been found to reduce the wine more than twenty degrees from above 70 degrees Fahrenheit (F.) to below 50 degrees F., within the range often preferred for white wines. Less ice or ice with less surface area exposed to the wine than crushed ice, such as ice cubes, may be used for a lesser temperature reduction, as may be desired for red wines, many of which are preferably served between about 55 and 66 degrees F.

If no direct exposure to ice is desired, the strainer may still be used. A liquid cooling device other than ice, such as plastic “ice cubes,” may be placed in the strainer to cool the wine without directly exposing the liquid to ice. Another liquid cooling device may be comprised of ice stored in a bag or sealed container capable of conducting the cooling effect of the ice to its exterior surface that contacts the wine. The bag or container is placed in the strainer. These methods also may be used to cool other beverages than wine, such as mixed alcoholic drinks and juice.

When the strainer 200 and receiving cup 220 are not in use, they may be stored such that cup 220 may be inserted into strainer 200. The cup may have recesses 222 and 224 sized to receive strainer flanges 206 and 208. The cup and strainer thus occupy minimal space when stored.

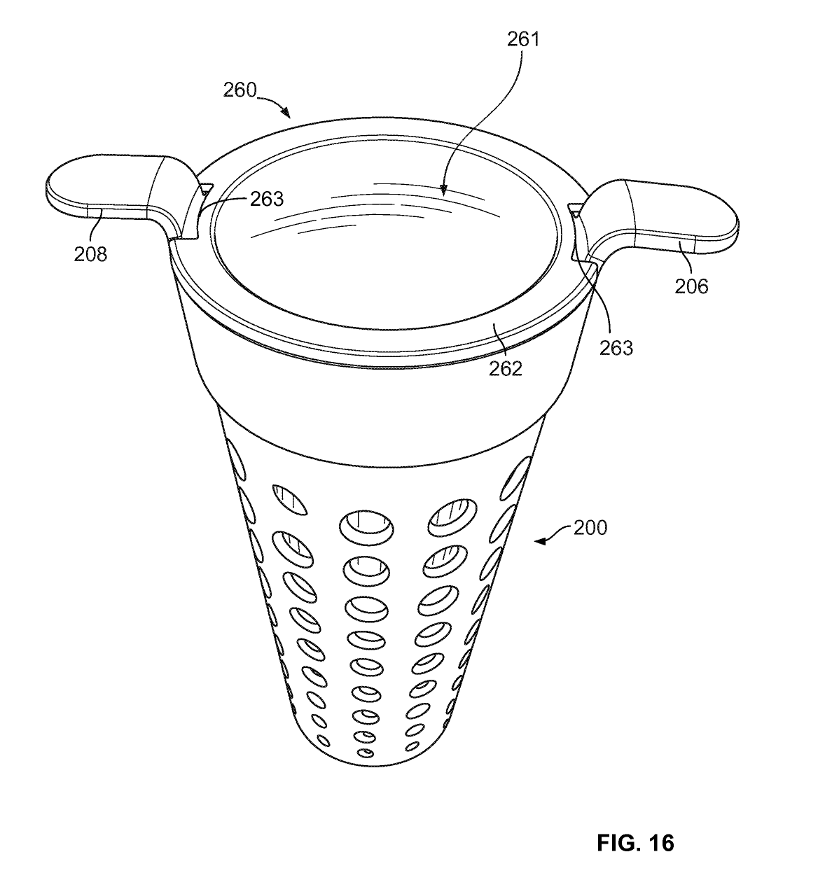

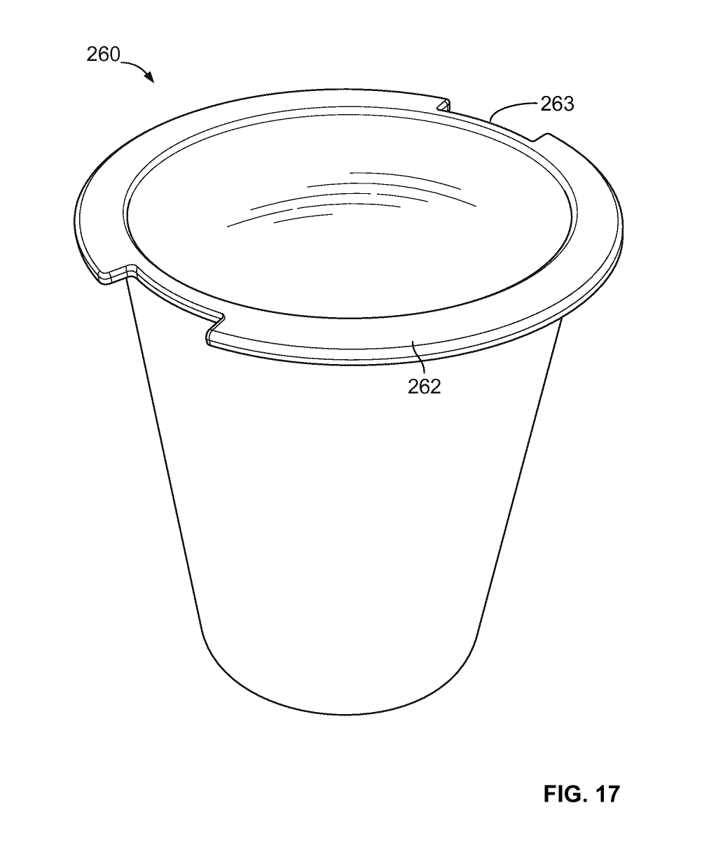

FIGS. 16 and 17 show an insert 260 for use with strainer 200. Insert 260 includes a cup portion 261 sized to be received in strainer 200. Insert 260 also has a projecting upper rim 262 with at least one recess 263 capable of receiving strainer flanges 206 and 208 to at least partially retain insert 260 in position when insert 260 is stored in strainer 200.

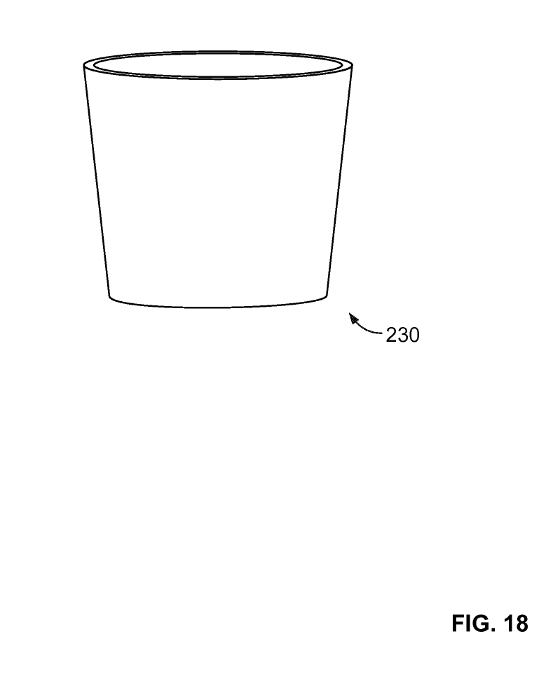

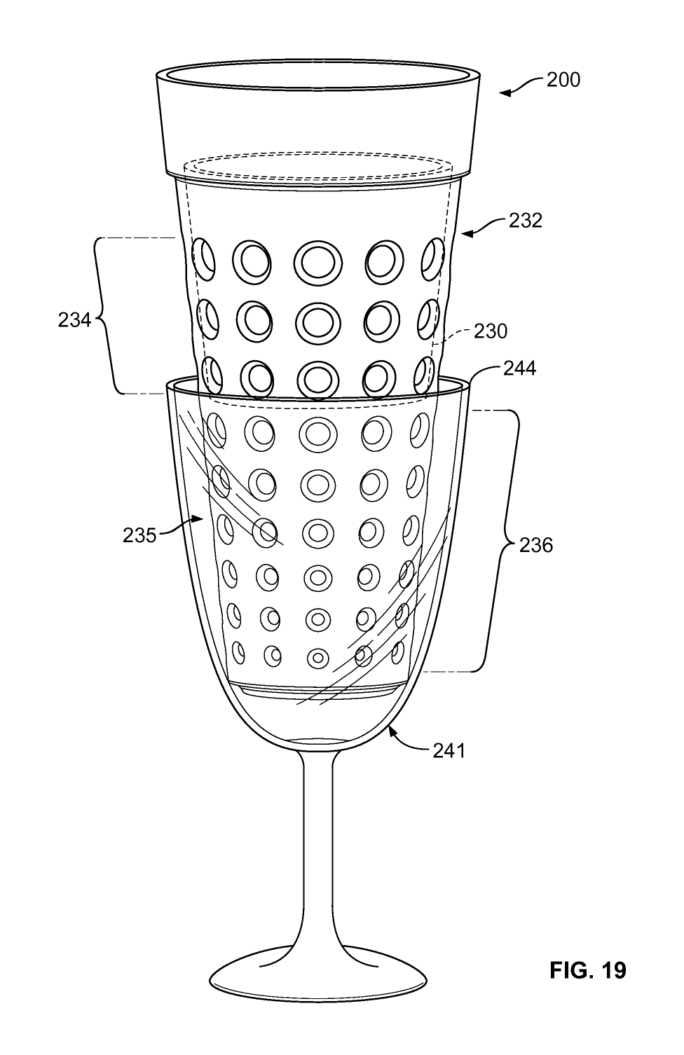

FIGS. 18 and 19 show an insert 230 in use with strainer 200, thereby adapting the strainer having holes in the middle region 234 for use with wine glasses 241 or other beverage containers which have upper rims below at least some of the holes of the middle region 234 of the strainer when the strainer is placed inside the containers. Insert 230 has a tapered shape capable of sliding into an upper sleeve receiving portion 232 of strainer 200. The sleeve extends into the strainer only a portion of the total length of the strainer, to ensure that the holes 236 in the lower portion of the strainer may serve to allow liquid to pass between the strainer and the glass in which the strainer is inserted. The exterior of the sleeve is sized and shaped to rest against the upper sleeve receiving portion 232, thereby blocking or impeding the flow of liquid through the holes of the middle region 234. By impeding such flow, which may otherwise cause liquid to flow out of the strainer above the top edge of the beverage container, leakage is minimized. Thus, the same strainer is adaptable for use both with taller beverage containers and with wine glasses or other relatively shorter containers.

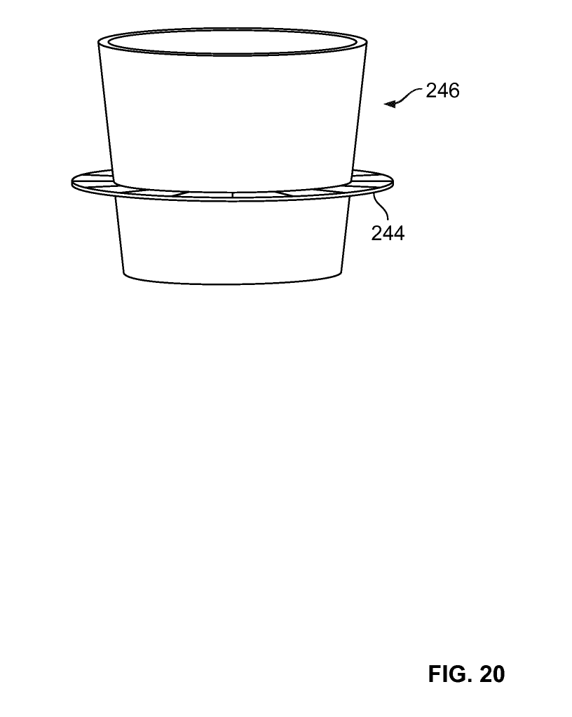

FIG. 20 shows an alternative embodiment of a sleeve 240 in which the sleeve is sized to slide onto the exterior of strainer 200. This embodiment includes a projecting rim section 244 capable of resting on or near the rim of a wine glass or other glass or beverage drinking container in which the strainer and sleeve 240 are placed. The sleeve 240 not only blocks wine from flowing out of any holes 234 in the middle region of strainer 200, but also blocks the flow of liquid or foam above the projecting rim, further minimizing spills and leaks.

Multiple versions of sleeves 230, 240 may be provided of differing sizes, to adapt the strainer for use with a variety of shapes and sizes of beverage containers. A longer sleeve, or a narrower sleeve that fits near the bottom of the strainer, for example, may be desirable for particularly shallow glasses such as martini glasses. A sleeve may also be sized to block the holes above the top of the receiving cup 220. This may also facilitate the use of the strainer and cup to microwave vegetables with a minimum of leakage or mess. The sleeve 230 also may readily be stored within the strainer when not in use, saving storage space.

The system as described may include the combinations of (1) strainer and cup, (2) strainer and sleeve insert, (3) strainer, cup and sleeve insert. As described above, the cup and sleeve insert may both be sized to readily store inside the strainer. Moreover, the three pieces may be sized such that the sleeve and cup may both be stored within the strainer simultaneously, for example by inserting the sleeve inside the strainer, and then inserting the cup inside the sleeve and strainer.

The present disclosure should not be considered limited to the particular examples described above, but rather should be understood to cover all aspects as fairly set out in the attached claims. Various modifications, equivalent processes, as well as numerous structures may be applicable will be readily apparent to those of skill in the art upon review of the instant specification.

What is claimed is:

1. A strainer for use with combining beverages and cold food, the strainer comprising:
a bottom section sized for insertion into a beverage container; and
a side section extending vertically from the bottom section and sized for insertion into a portion of the beverage container, the side section having an upper portion having a shoulder that projects substantially laterally with respect to the upper portion;
wherein at least one of the bottom section and at least a lower portion of the side section is liquid permeable; and
wherein the bottom section and the side section are separately or collectively capable of retaining ice pieces when the strainer is inside the beverage container, and the upper portion projects substantially around a circumference of the strainer such that the shoulder is capable of resting on a top edge of the beverage container in which the strainer is inserted to impede leakage of foam or liquid from the beverage container.

2. A strainer system, comprising:
a strainer, the strainer having:
a bottom section sized for insertion into a beverage container;
a side section projecting substantially vertically from the bottom section and sized for insertion into a portion of the beverage container; and
an upper portion having a shoulder that projects laterally to impede leakage of foam or liquid from the beverage container;
wherein at least one of a bottom and side sections is liquid permeable; and
wherein the bottom section and the side section are separately or collectively capable of retaining ice pieces when the strainer is in the beverage container; and
a first sleeve insert capable of being retained in an upper region of the interior of the strainer such that the first sleeve impedes a permeability of an upper section of a liquid permeable section and is positioned above a lower section of the interior of the strainer having a liquid permeable section.

3. The strainer system of claim 2, further comprising a cup sized to receive at least a portion of the strainer such that the strainer is configured to be placed within the cup to allow drainage into the cup.

4. The strainer system of claim 2, further comprising a cup sized to receive at least a portion of the strainer such that the strainer is capable of being placed within the cup to allow drainage into the cup, wherein the cup is sized such that at least a portion is capable of being inserted into the strainer.

5. The strainer system of claim 2, wherein the strainer has at least one flange projection extending laterally from the upper portion of the strainer, and wherein a cup has a projecting upper rim with at least one recess capable of receiving the flange projection to at least partially retain the cup in position when the cup is stored in the strainer.

6. The strainer system of claim 2, wherein the first sleeve insert is placed within the strainer, and further comprising a wine glass capable of receiving the strainer engaged with the first sleeve insert.

7. The strainer system of claim 2, further comprising at least a second sleeve insert of a different size than the first sleeve insert and capable of being retained in a second upper region of the interior of the strainer such that the second sleeve insert impedes the permeability of a different portion of the upper section of the liquid permeable section different than the portion of the upper section impeded by the first sleeve insert and sized to be positioned above a lower region of the interior of the strainer having the liquid permeable section.

8. A method for cooling beverages, comprising:
engaging a sleeve member with a strainer capable of retaining ice such that a lower portion of the strainer remains liquid permeable and the sleeve member impedes a permeability of a middle liquid permeable portion of the strainer;
placing the strainer in a beverage drinking container;
adding ice to the strainer either before or after placing the strainer in the beverage drinking container such that at least some ice is retained by the strainer;
pouring a beverage over the strainer while the sleeve member is engaged with the strainer and while the strainer is in the beverage drinking container such that the beverage is cooled and exits the strainer through said lower portion of the strainer and is retained in the beverage drinking container; and
removing the strainer from the beverage drinking container after pouring the beverage.

9. The method as in claim 8, wherein the beverage is wine.

10. The method as in claim 9, wherein the beverage drinking container is a wine glass.

11. The method as in claim 8, wherein the sleeve member has a projecting circumferential rim and the strainer engages with the sleeve member by inserting the strainer into the sleeve member, and wherein the placing the strainer least partially within the beverage drinking container further comprises placing the strainer with the sleeve member engaged therewith such that a projecting rim of the sleeve member in which the strainer is inserted rests on or near a top edge of the beverage drinking container.
